(19) United States
(12) Patent Application Publication
(10) Pub. No.: US 2025/0180463 A1
(43) Pub. Date: Jun. 5, 2025

(54) PHOTON SIGNAL PROCESSING FOR CONSTANT INTENSITY EXCITATION FOR PARTICLE DETECTION

(71) Applicant: MIFTEK CORPORATION, West Lafayette, IN (US)

(72) Inventors: Masanobu Yamamoto, West Lafayette, IN (US); J. Paul Robinson, West Lafayette, IN (US)

(73) Assignee: MIFTEK CORPORATION, West Lafayette, IN (US)

(21) Appl. No.: 18/970,504

(22) Filed: Dec. 5, 2024

Related U.S. Application Data
(63) Continuation of application No. 63/606,432, filed on Dec. 5, 2023.

(51) Int. Cl. G01N 15/1434; G01N 15/14; G01P 3/36

(52) U.S. Cl. CPC G01N 15/1434; G01N 15/147; G01N 2015/1493; G01P 3/36

(57) ABSTRACT

A flow cytometry system includes a flow chamber configured to flow particles of interest in a flow stream, one or more optical sources, one or more rectangular fiberoptics optically each coupled to the one or more optical sources and further optically coupled to the flow chamber and configured to excite the particles of interest in the flow stream, the particles of interest emitting emission light in response to being excited by the excitation light, one or more photodetectors configured to receive emission light from the particles of interest and, each in response generate a response signal, wherein the one or more rectangular fiberoptics each generate a flattop intensity response in both direction of flow and in a direction perpendicular to the direction of flow.

### CROSS-REFERENCE TO RELATED APPLICATIONS

This application claims priority to and the benefit of U.S. Provisional Patent Application No. 63/606,432, filed Dec. 5, 2023 and entitled “PHOTON SIGNAL PROCESSING FOR CONSTANT INTENSITY EXCITATION FOR PARTICLE DETECTION,” which is incorporated in its entirety herein by reference into the present disclosure.

### STATEMENT REGARDING GOVERNMENT FUNDING

None.

### TECHNICAL FIELD

The present disclosure generally relates to flow cytometry, and in particular to a system with a rectangular fiberoptic with and without diffusing beads capable of providing A) a robust optical coupling efficiency thereby allowing a wide range of optical sources including incoherent light sources; and B) flattop intensity response in i) direction of flow and ii) in a direction perpendicular to the direction of flow which in both directional cases are substantially free of intensity variation.

### BACKGROUND

This section introduces aspects that may help facilitate a better understanding of the disclosure. Accordingly, these statements are to be read in this light and are not to be understood as admissions about what is or is not prior art.

Flow cytometry is ubiquitously used in the fields related to life sciences such as genetics, immunology, molecular biology, and environmental science. In general terms, flow cytometer/cytometry refers to a systems/method used to i) detect, and once detected ii) measure physical and chemical attributes of particles moving along with a sheath fluid across an interrogation window such that only one such particle appears at a time for interrogation. Referring to FIG. 1A, a general block diagram is provided showing the components typically seen in a flow cytometry system. Typically a flowcytometry system includes an excitation module adapted to provide optical excitation, a systems controls module adapted to control various blocks in the system, a microfluidic module adapted to provide a fluidic path for particles to be studied, an electronic module adapted to process signals generated from studying said particles, an emission module adapted to receive optical emission from said particles, and a number of other blocks such as a sensor system, a data display block, a data collection block, an imaging module, a sorting module collectively adapted to provide a visual representation of said particles. Additionally, there is a sample module that provides particles to be studied, a flow chamber for orderly passage of said particles through the microfluidic module, and a sort or waste module for physical processing of said particles.

A source of light is housed in an excitation module which is used to shine light at various wavelengths onto said particles. Light that is incident on such particles is scattered, typically in a forward or side scatter and detected by photodetectors positioned about the direction of such scatters. Light scattered from the particles are considered as emissions as compared to the excitation light that is from the source of light. These photodetectors are typically photodiodes or photomultiplier tubes. In both cases, detectors generate electrons when excited by photons of the emitted light from the particles. Typically the current from the excited electrons is measured and labeled as the photocurrent. The photocurrent can be correlated to general population data of the particles, and some information about heterogeneity of the population. Common light sources includes coherent light sources such as lasers and incoherent light sources such as halogen bulbs and light emitting diodes. Common lasers include ultraviolet (UV) having a wavelength of 355 nm to 360 nm, violet having a wavelength of 405 nm to 407 nm, blue having a wavelength of 488 nm, red having a wavelength of 633 nm, yellow having a wavelength of 561 nm, and green having a wavelength of 532 nm. Blue laser is found to be the most common.

The majority of laser types in current use produce output beams with circular or elliptical cross-sections, with either Gaussian or near-Gaussian intensity profiles. This Gaussian intensity distribution is acceptable, and often beneficial for many applications in which the laser beam is being focused to a small spot. However, there are also many different uses for which a uniform intensity distribution (often referred to as a “flattop”) would be more optimal. There are several ways to convert a Gaussian beam into a uniform intensity distribution.

The most simple and direct way to transform a Gaussian beam into a uniform intensity distribution is to pass the beam through an aperture which blocks all but the central, and most uniform portion of the beam. There are two disadvantages to this approach. First, a very large fraction of the laser power is discarded, as much as 75%. Second, the resulting beam still has a substantial falloff in intensity from the center to the edge. Additionally, other optical elements are often needed to clean up the beam by removing stray lobes produced by diffraction from the aperture edge. The main approach for making the aforementioned transformation is based on the user of diffractive measures.

Diffractive optics operate by creating interference between various diffracted orders to redistribute the incident intensity distribution. Diffraction effects are by their very nature highly wavelength dependent; therefore, a given diffractive optical element will only work over a narrow wavelength range. This wavelength sensitivity becomes particularly problematic when pairing diffractive elements with diode lasers since such lasers have a relatively large wavelength bandwidth as compared to other laser types. Also, there are large unit-to-unit variations in the nominal output wavelength of such laser diodes. Additionally, diffractive optical elements also always place at least some light into unwanted diffraction orders.

Generally, flattop beams are not as cost-efficient as Gaussian beams, as additional beam shaping components are required to convert the laser's output into a flattop beam. This beam shaping assembly can be built into the laser source or placed outside of the laser. These additional beam shaping assemblies are sensitive to x-y alignment and dependent on input beam diameter. Flattop laser beams also do not remain constant under transformations; consequently, the beam profile of an incident flattop beam is not naturally preserved as the beam propagates.

A commercial beam shaper device is typically required to obtain a flattop beam signature. According to one example, a πShaper, provided by EDMUND OPTICS is an efficient beam shaper capable of transforming a Gaussian intensity profile to a flattop profile for a variety of different coherent source of different wavelengths. Referring to FIG. 1B, an example of the πShaper is provided along with said transformation.

According to another example, optical elements are incorporated into the lasers used in a well-known flow cytometer manufactured by THERMOFISHER SCIENTIFIC's Attune model, as provided in FIGS. 2A and 2B. The beam shaping optics were integrated into a module that can be added to a laser in free space, or even a module that is attached to the end of a fiberoptic (such as Coherent achieve with the lasers on the Attune model which provides a beam shape of 10×50 μm flattop laser).

As a result of the beam shaping, the goal of flattop beams is to have a constant irradiance profile through the cross-section of the laser beam, however, there is still some variation in intensity. Some applications benefit from a constant intensity over a given area, including the processing of semiconductor wafers, nonlinear frequency conversion at high power levels, and materials processing. Compared to Gaussian beams, flattop beams often result in more accurate and predictable results, such as cleaner cuts and sharper edges, but they come with additional system complexity and significant cost.

In particular, a significant amount of laser energy is discarded as demonstrated by FIG. 3 which shows the Gaussian beam being transformed to a flattop and how the top portion of the beam is simply left unused.

Furthermore, the flattop intensity profile is not only useful in the direction of flow in a cytometry setting, but also in the substantially perpendicular direction to the flow direction. However, no such beam shaper is known which is capable of not only shaping the beam in the flow direction, but also in a direction to the flow direction, and providing precise and improved near-constant intensity.

Additionally, the coupling efficiency between the coherent light source in the traditional flow cytometry and the fiberoptic is limited to the aperture of the traditional circular or oval fiberoptic. This poor coupling efficiency dictates a high-power coherent light source, which are typically quite expensive.

Finally, the prior art implementations require a significant number of complex components such as prisms that need to be situated in a highly sensitive manner. Such placements are sensitive to jarring and unintentional movement and thus require occasional calibration.

Therefore, there is an unmet need for a novel flow cytometer system that can provide a robust optical coupling efficiency between a light source and a fiberoptic thereby allowing a wide range of light sources including incoherent light sources and a flattop intensity response in i) direction of flow and ii) in a direction perpendicular to the direction of flow which in both directional cases are substantially free of intensity variation.

### SUMMARY

A flow cytometry system is disclosed. The system includes a flow chamber configured to flow particles of interest in a flow stream, one or more optical sources, one or more rectangular fiberoptics optically each coupled to the one or more optical sources and further optically coupled to the flow chamber and configured to excite the particles of interest in the flow stream, the particles of interest emitting emission light in response to being excited by the excitation light, one or more photodetectors configured to receive emission light from the particles of interest and, each in response generate a response signal. The one or more rectangular fiberoptics each generate a flattop intensity response in both direction of flow and in a direction perpendicular to the direction of flow.

A method of studying particles of interest in a flow cytometry system is also disclosed. The method includes flowing particles of interest in a flow stream in a flow chamber, activating one or more optical sources, optically coupling one or more rectangular fiberoptics each to the one or more optical sources and further optically coupling to the flow chamber to thereby exciting the particles of interest in the flow stream, the particles of interest emitting emission light in response to being excited by the excitation light, detecting the emission light from the particles of interest by one or more photodetectors, each in response generating a response signal. The one or more rectangular fiberoptics each generate a flattop intensity response in both direction of flow and in a direction perpendicular to the direction of flow.

### BRIEF DESCRIPTION OF THE DRAWINGS

FIG. 1A is a general block diagram showing the components typically seen in a flow cytometry system.

FIG. 1B is a photograph of an example of a πShaper known in the prior art with a transformation from Gaussian intensity profile to a flattop profile.

FIGS. 2A and 2B are a schematic (FIG. 2A) of a system with optical elements incorporated into lasers used, along with a transformation showing intensity being transformed from a Gaussian profile to a flattop profile (FIG. 2B).

FIG. 3 provides two diagrams showing conversion from a gaussian profile to a flattop profile and how a significant amount of laser energy is discarded.

FIG. 4 is a schematic of a traditional flow cytometry setup.

FIG. 5 graphs of four different schemes are schematically shown, with three such schemes belonging to the prior art, and one to the present disclosure, showing variability in pulse width, pulse intensity associated with particles of interest and coefficient of variation for each such scheme.

FIG. 6 is a schematic showing various intensity profiles without using a rectangular fiberoptic and then an intensity profile with a rectangular fiberoptic according to the present disclosure.

FIG. 7 provides two rows of outputs from rectangular fibers on black screens, according to the present disclosure.

FIG. 8 is a schematic of a light source, e.g., an incoherent light source, e.g., an ultraviolet light emitting diode (UV LED), and how it is coupled to a rectangular fiberoptic of the present disclosure via a collimating lens and a focusing lens.

FIG. 9 is a schematic of an incoherent light source that is optically coupled to a rectangular fiberoptic via a tapered fiberoptic.

FIG. 10 is a perspective view of a rectangular fiberoptic according to the present disclosure.

FIG. 11 is a photograph of an experimental setup, according to the present disclosure, along with a schematic of components used in the setup.

FIG. 12 are schematics of excitation patterns to further show the improvement in near constant intensity and accuracy when using a laser array between, e.g., elliptical patterns and the rectangular patterns of the present disclosure.

FIG. 13 provides a series of graphs of excitation photon density vs. power in mW each for a different wavelength each coupled to a rectangular fiberoptic, according to the present disclosure.

FIGS. 14A 14B, and 14C provides diagrams for how flow velocity and size of a particle is determined based on spot distance as determined by two or more neighboring lasers in an array vs. measure time of flight Δts using formula v=spot distance/Δts, where spot distance is known exactly based on predefined spacing between two or more neighboring outputs in the array.

FIG. 15 is another schematic of yet another improvement by utilizing diffusing beads, in which a coherent light source, e.g., a laser, is shown as a spot via a fiberoptic representing speckle-like intensity variation within an envelope, and where this artifact is improved by use of diffusion beads thus providing improved uniformity.

FIG. 16 is a schematic showing micro-diffusers at the entrance of a rectangular fiberoptic, according to the present disclosure.

FIG. 17 is a schematic showing how micro-beads are aligned and bonded to a substrate using a bonding agent and cured utilizing, e.g., a UV curing light.

FIG. 18 provides rectangular fiberoptic output of three different light sources (first one is an incoherent halogen light source where no deviation in light intensity within the rectangular enveloped is observed, the second one is a coherent He—Ne laser where within the rectangular envelope a speckle-like variation in intensity is observed, and the third light source is a laser diode (642 nm) with diffuser beads showing a considerable reduction in the speckle-like variation of intensity within the rectangular envelope).

FIG. 19 provides schematics which show advantage of a fiber array with rectangular fiberoptics whereby each rectangular profile is fixedly separated from another rectangular profile, thus allowing uniformity for flow velocity and particle size calculations.

FIGS. 20 and 21 are schematics of a 7-channel array, where each channel can be coupled to a corresponding light source, e.g., coherent lasers of different wavelengths without any interference from one channel to another.

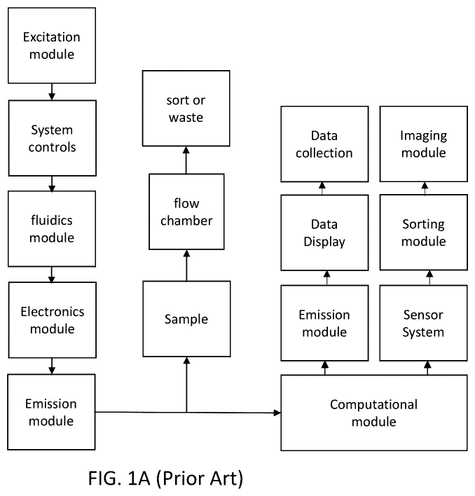

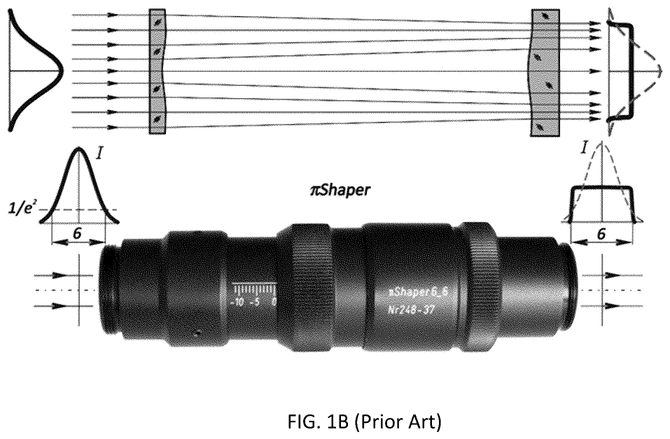

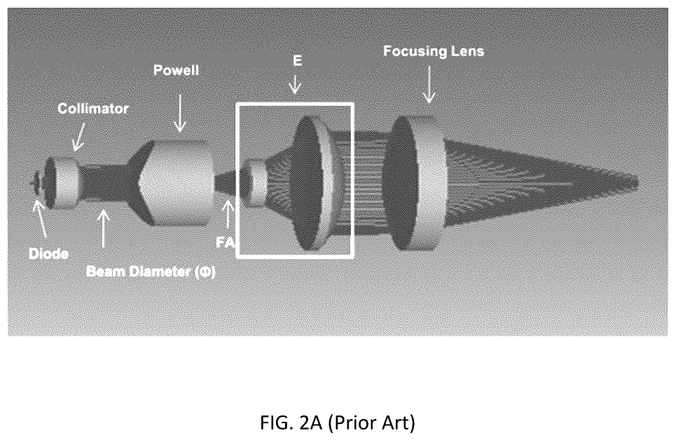

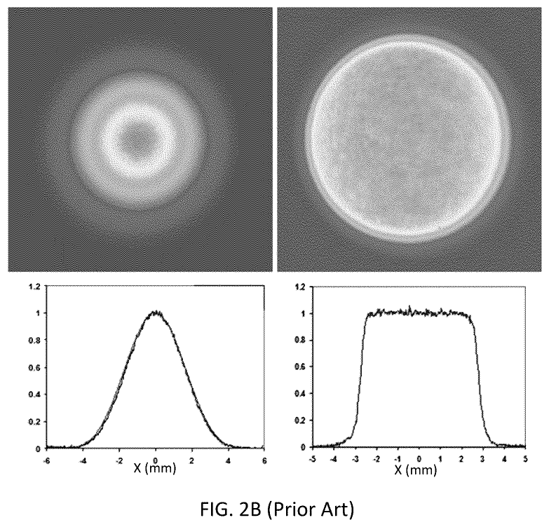

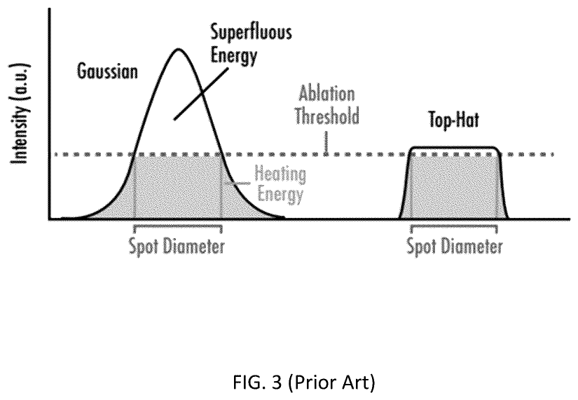

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel flow cytometer system is presented herein that can provide a robust optical coupling efficiency between a light source and a fiberoptic thereby allowing a wide range of light sources including incoherent light sources and an improved precise and near constant flattop intensity response in i) direction of flow and ii) in a direction perpendicular to the direction of flow which in both directional cases are substantially free of intensity variation. Towards this end a rectangular fiber is used in connection with a light source. Since the aperture size of a rectangular fiber is much greater than a round or oval fiber, the coupling efficiency between the rectangular fiber and the light source is significantly higher. As a result a broader selection of light sources, including incoherent light emitting diodes (LEDs) can be used as the light source. Furthermore, the output of the rectangular fiberoptic provides a flattop intensity profile as a function of distance from the center of the output beam without the aforementioned waste of power. The profile is a flattop profile in both the flow direction and a direction perpendicular to the flow direction. Additionally, use of diffracting beads in the rectangular fiber substantially improves variations in the flattop portion of the profile. In particular, the diffraction beads provide a sort of pseudo lowpass optical filter functionality to the intensity profile in the flattop portion of the profile.

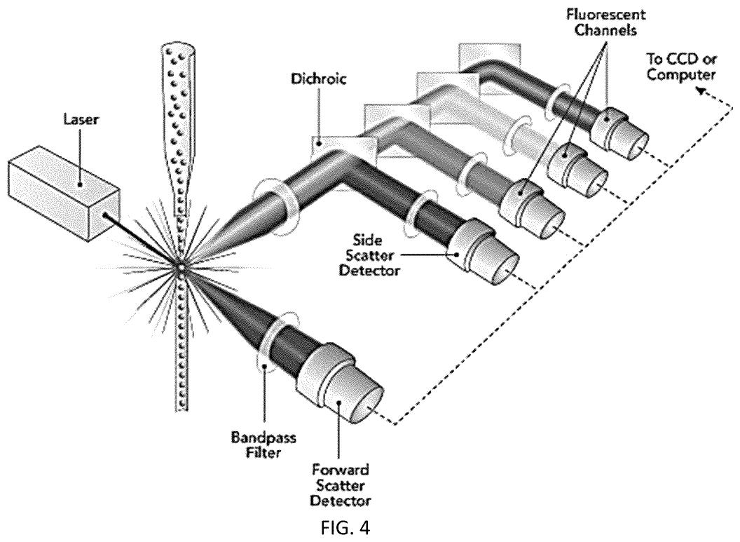

Referring to FIG. 4, a schematic of a traditional flow cytometry setup is shown. As particles in the flow tube come across the laser beam that is either directly incident or shone via a round or oval fiberoptic, the particles fluoresce and by use of a dichroic mirrors or other re-directional components, those fluorescent emissions are routed to detectors.

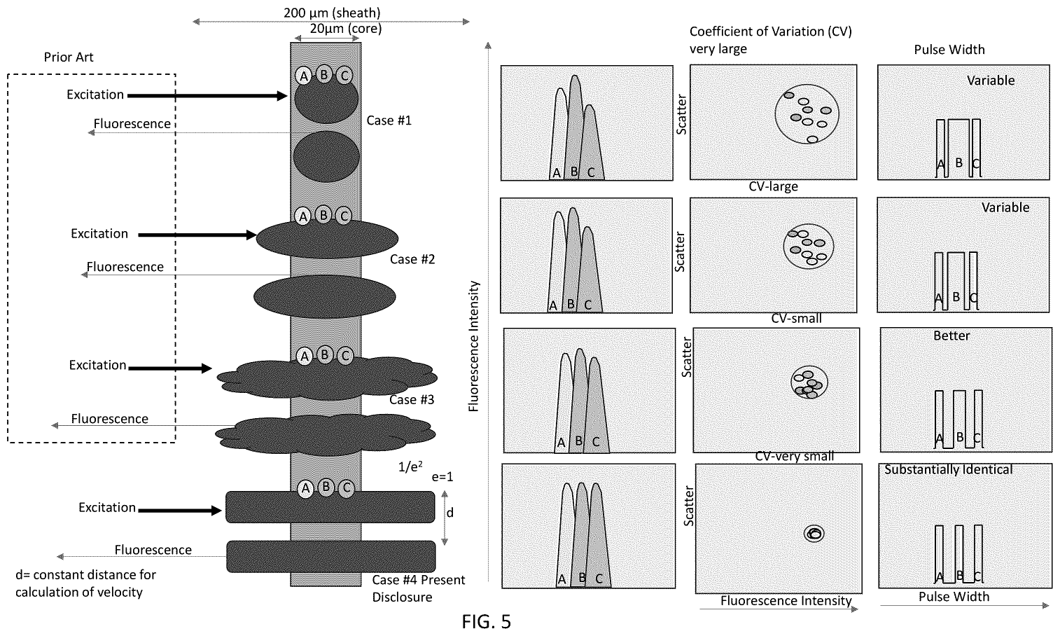

As discussed above, there has been a desire to generate consistent intensity profiles across the flow channel. The reason for goal is described in relationship with FIG. 5. In FIG. 5 four sets of schemes are schematically shown, with three such schemes belonging to the prior art. In each case the excitation cross section represents a cross-sectional profile owing to a light source, e.g., a laser being shone through the page. In each case two such light sources are shown one after another. Thus the light sources are either behind the page or in front of the page. In each case, three particles A, B, and C are depicted in the exact same position with respect to the different cross-sectional profiles. In the first case, identified as Case #1, a round or semi-round cross-sectional profile is shown. As seen in FIG. 5, in Case #1 each particle receives a different amount of intensity from the shone light, since intensity in the center of each cross-sectional area in this case is the maximum and decreases towards the edge of the cross-sectional area. Therefore, particles A and C receive smaller intensity, while particle C receives the maximum intensity. As a result, the intensity profiles from the fluorescence emission varies. Additionally, the pulse width with respect to each particle also varies. The relative time of flight for particle B through the light is longer than those for particles A and C. These variations present significant challenges. For example, pulse width from one light source to the next source is used to calculate size and velocity of the particles. Variations in pulse width can be detrimental to the accuracy of these results. Thus, as shown schematically, both fluorescence intensity as well as pulse width varies significantly between particle B and particles A and C. Also shown is the coefficient of variance (CV) in the form of a scatter plot showing a high level variance.

In the second case, the above-described variations are diminished, however, they still pose a significant challenge.

In the third case, optical components are used to generate a flat-top response. While the variation in fluorescence and pulse width are reduced, they still pose a challenge when using these variable to determine particle size and velocity. This variation is due to the non-uniformity of the cross-sectional profile.

Thus, in general, an elliptical spot excitation is sensitive to position shift and particle size, thus the detected intensity deviation affects coefficient of variation (a unitless, dimensionless metric useful in measuring variation of flow cytometry data). As a result, a large aspect ratio results in a larger spot on Y-axis, excessive surface reflection effect, and causes instability on alignment.

In the last case, a rectangular fiber is shown, according to the present disclosure. All the particles receive substantially the same intensity in each case along with the same pulse width resulting in much improved downstream calculations.

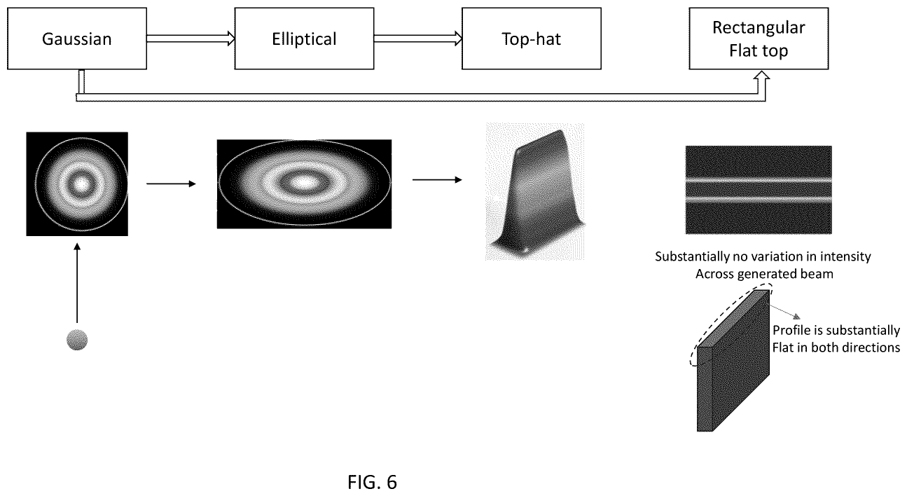

The cross-sectional profiles from the prior art and the present disclosure are further compared in the schematics of FIG. 6. On one side of FIG. 6, a round intensity varying light source is shown. The intensity of the light source is represented by different portion (towards center being highest intensity and radiating away from the center representing lower intensities). In the case of prior art, use of optical components (filters, prisms, etc.) results in improvement in intensity variation, e.g., the center in the elliptical excitation is longer thus resulting in a smaller variation, as well as the Top-hat implementation resulting in a near-constant intensity in one direction, but Gaussian in a perpendicular direction. As shown a cross section of this substantially flattop intensity response produces a Gaussian profile across the flattop (again shown as multicolor response with red representing the highest intensity). However, in the case of the rectangular fiber according to the present disclosure, a cross section across the flattop results in a uniform intensity response shown as a single color in both directions resulting in improved response from the particles as the particles traverse through the uniform intensity light.

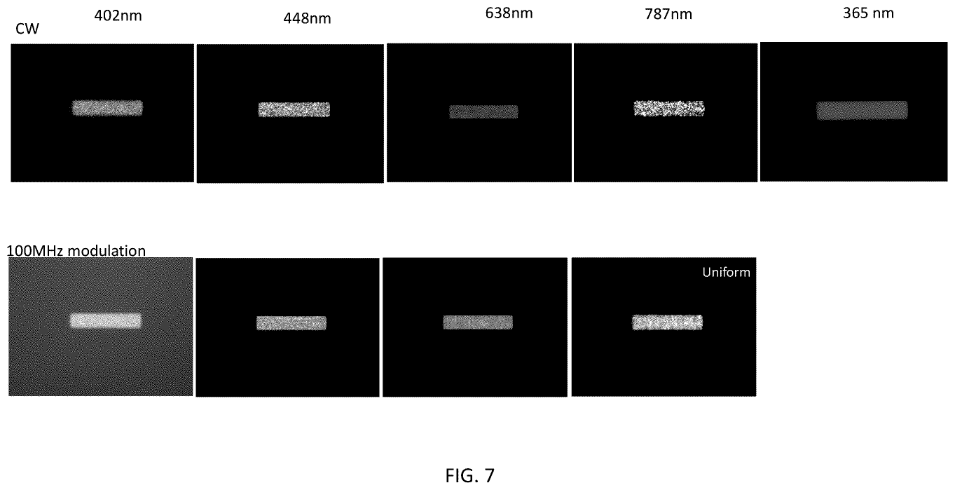

Referring to FIG. 7, two rows of outputs from rectangular fibers on black screens are provided according to the present disclosure. In each of these two rows, a rectangular fiber is optically coupled to a corresponding laser. The first row shows continuous wave (CW) lasers having 402 nm, 448 nm, 638 nm, 787 nm, and 365 nm. The second row corresponding outputs for 402 nm, 448 nm, 638 nm, and 787 nm but with 100 MHz modulation to thereby improve uniformity. In other words, by modulating the CW lasers, the speckle outputs shown in the first row are improved.

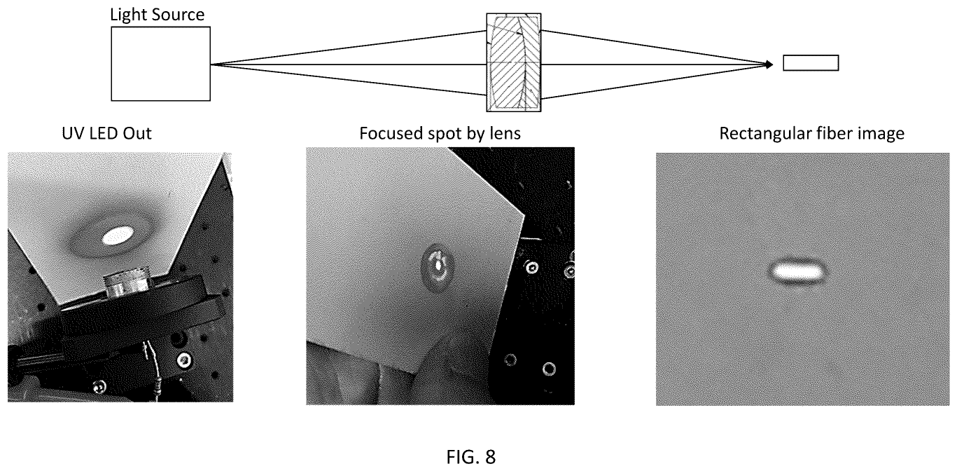

Referring to FIG. 8, a light source, e.g., an incoherent light source, e.g., an ultraviolet light emitting diode (UV LED), is coupled to a rectangular fiberoptic of the present disclosure via a collimating lens and a focusing lens. In the first case, the output of the light source, is simply shone on a screen. In the second case, the output of the light source is shone on the screen but via the collimating lens and a focusing lens. In the third case, the output is shown in the screen via the collimating lens and a focusing lens but through the rectangular fiberoptic.

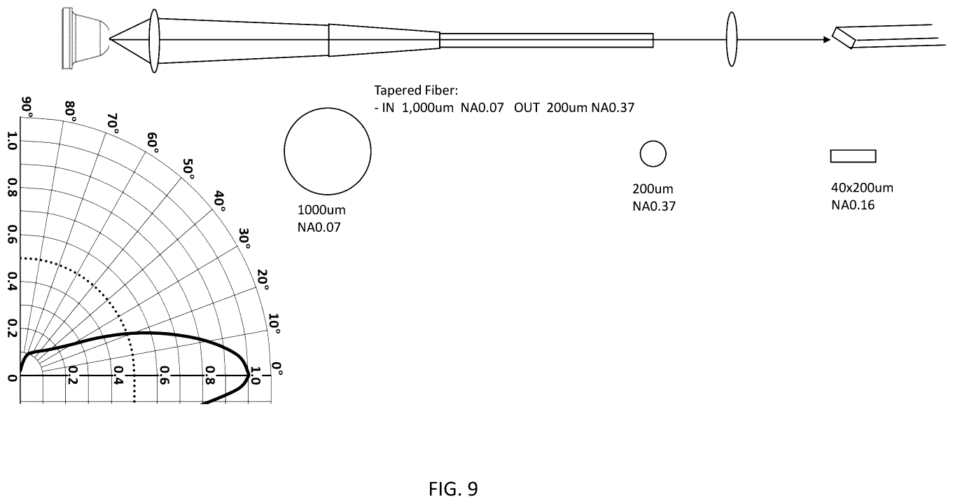

Referring to FIG. 9, an incoherent light source is shown that is optically coupled to a rectangular fiberoptic via a tapered fiberoptic. The tapered fiberoptic has a larger input, e.g., 1000 μm that is optically coupled to the light source via a first focusing lens, vs. a smaller output, e.g., 200 μm, that is coupled to a rectangular fiberoptic of the present disclosure via a second focusing lens. Also, while not shown, the tapered fiberoptic can be cascaded (i.e., a first tapered fiberoptic of diameter D₁ to D₂ coupled to a second tapered fiberoptic of diameter D₂ to D₃). It should also be appreciated that the tapered fiberoptic can be replaced with an optical coupling that is mechanically coupled to the light source.

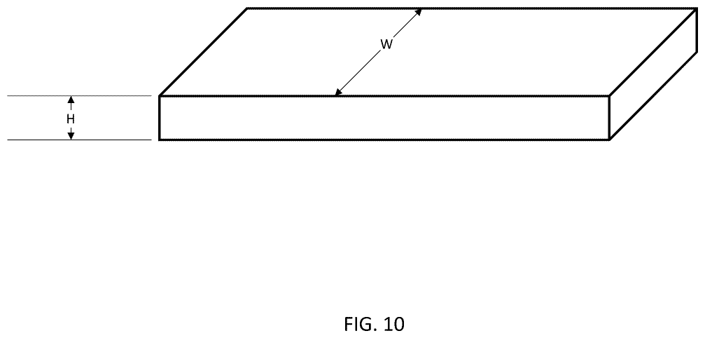

Referring to FIG. 10, a perspective view of the rectangular fiberoptic according to the present disclosure is provided. The rectangular fiberoptic is signified by a height (H), a width (W) and a length. The aspect ratio of the height to width (H×W) is between 1×1 to 1×10, including whole and fractional aspect ratios in between including 1×2, 1×3, 1×4, 1×5, 1×6, 1×7, 1×8, or 1×9 with height of the fiberoptic having a range of between about 10 to about 50 μm. The material for the rectangular fiberoptic includes materials typically used in fiberoptics including but not limited to homogenous transparent material, e.g., made of fused silica, glass, plastic (including acrylate and polyimide), graded index (gradual refractive index with highest refractive index at surface and lowest at center), and other materials known to a person having ordinary skill in the art. Additionally, what is shown in FIG. 10, is the core of the fiberoptic; however, as known to a person having ordinary skill in the art, the core is covered by cladding which is typically covered by buffer for protection. The cladding is typically made from fluoride-doped silica, while the buffer is typically made of plastic (e.g., acrylate).

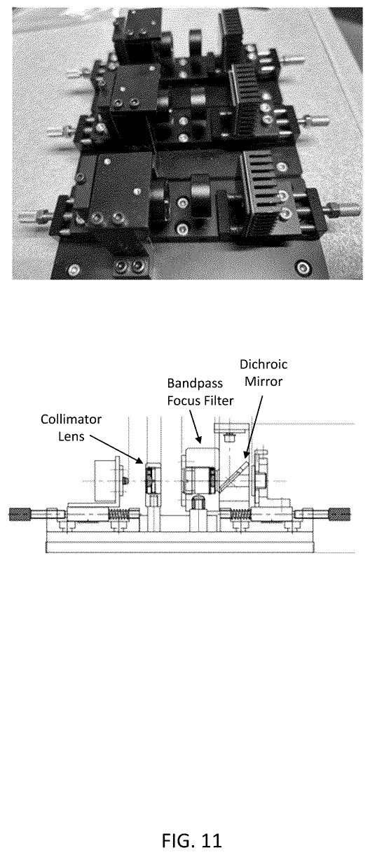

Referring to FIG. 11, a photograph of the experimental setup is shown, according to the present disclosure, along with a schematic of components used in the setup. In the setup an incoherent light source is used along with a collimator lens and a bandpass focusing lens which is then coupled to a rectangular fiberoptic (not shown). A dichroic mirror is also used to sample intensity of light prior to entering the rectangular fiberoptic.

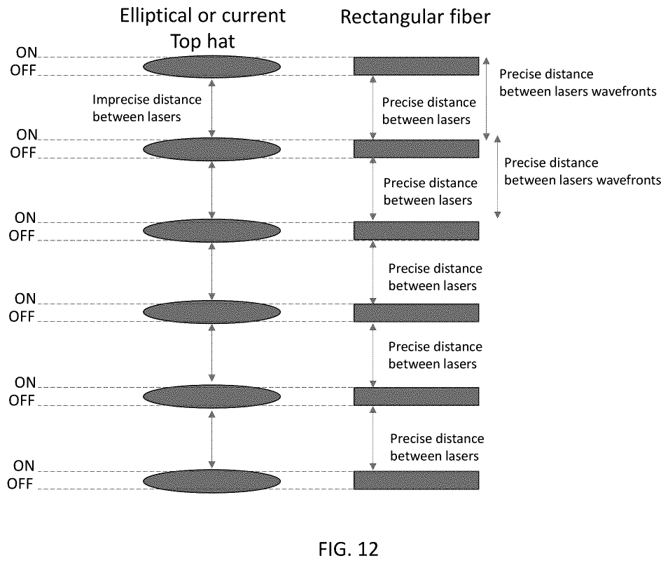

Referring to FIG. 12, schematics are provided to further show the improvement in near constant intensity and accuracy when using a laser array. A laser array typically uses a plurality of termination ports that are situated in a predefined relationship with each other, e.g., termination ports that are each a predefined distance away from a neighboring port. However, as shown in FIG. 12, even when an elliptical output is chosen for termination ports, an imprecise distance between the outputs exists in the array. However, by using a rectangular fiberoptic in a laser array, this problem is overcome as a precise distance between any two components of the array.

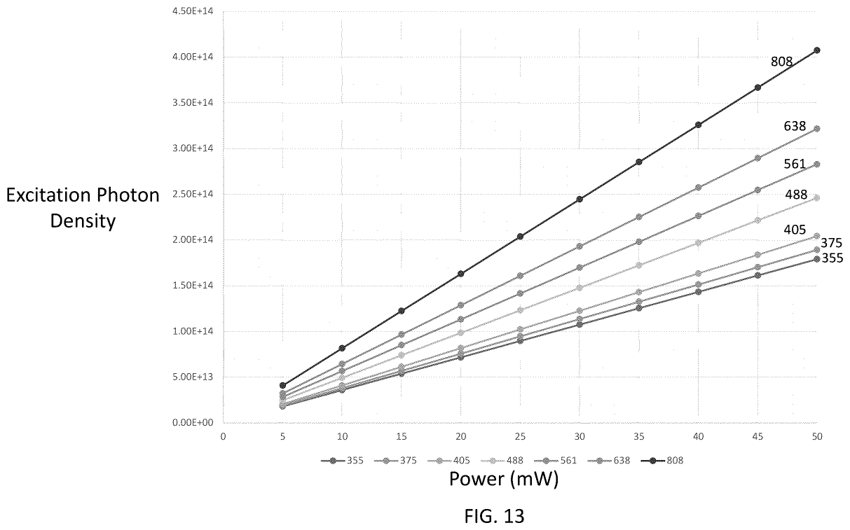

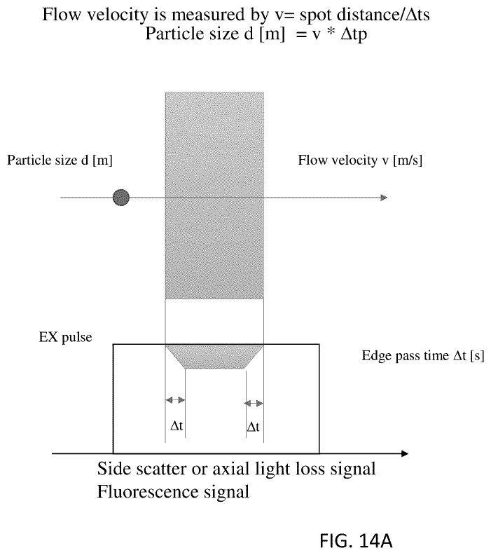

Referring to FIG. 13, a series of graphs of excitation photon density vs. power in mW each for a different wavelength is provided each coupled to a rectangular fiberoptic according to the present disclosure, showing a higher excitation photon density with higher wavelengths.

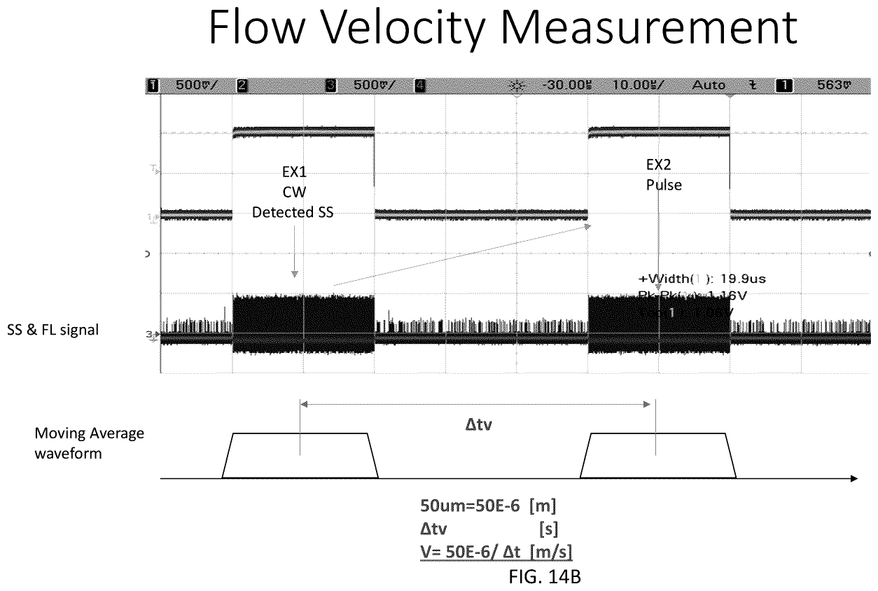

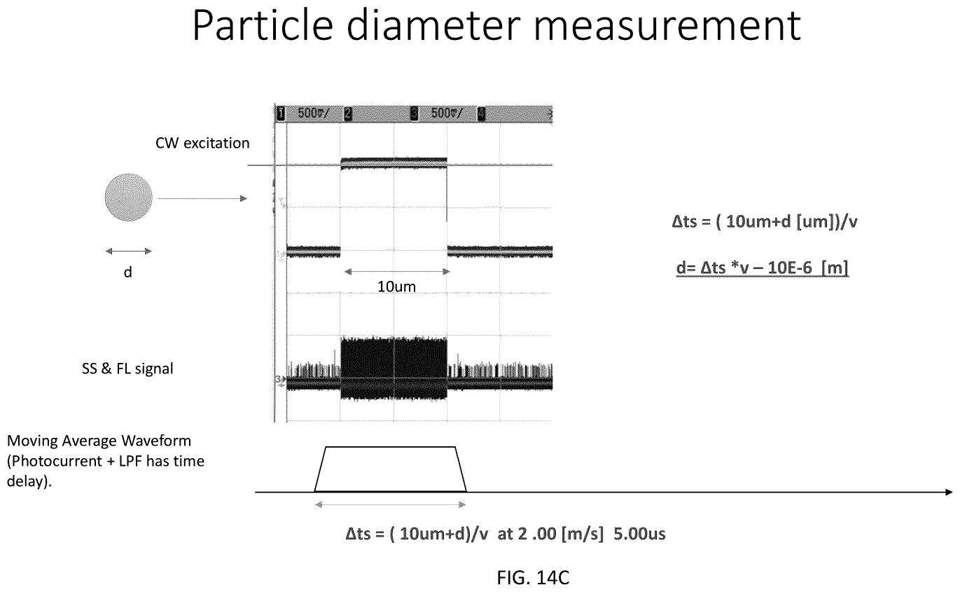

Referring to FIGS. 14A 14B, and 14C, flow velocity and size of a particle is determined based on spot distance as determined by two or more neighboring lasers in an array vs. measure time of flight Δts using formula v=spot distance/Δts, where spot distance is known exactly based on predefined spacing between two or more neighboring outputs in the array. This distance is advantageously uniform owing to the rectangular shape of the excitation light because of the rectangular fiberoptic. Similarly, particle size can be determined with a high level of accuracy based on using the aforementioned velocity based on time of flight of a particle across one such laser output using formula d=v Δtp where Δtp is the time of flight across height of an output.

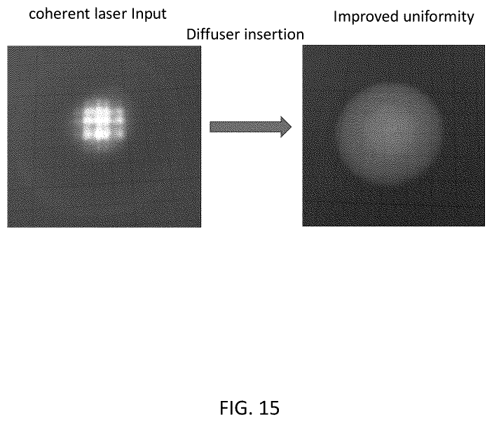

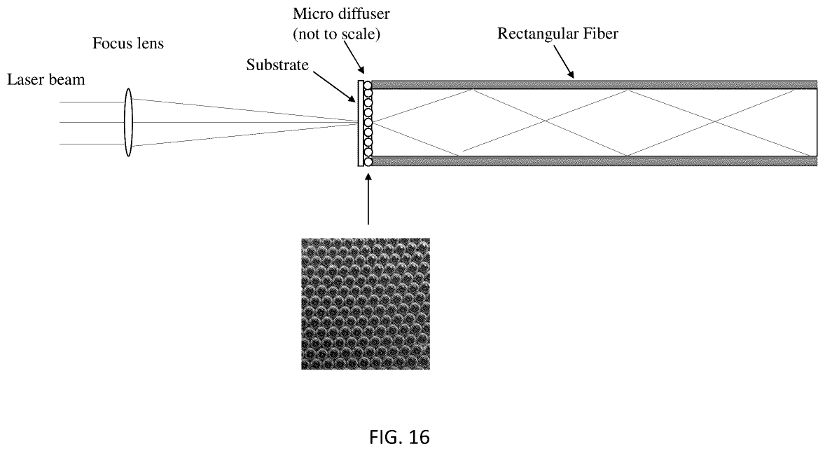

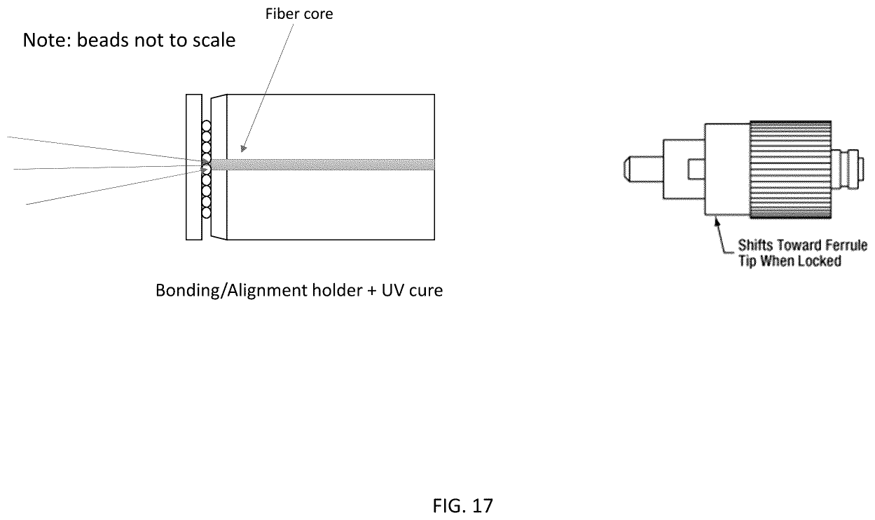

Referring to FIG. 15, yet another improvement is shown by utilizing diffusing beads. In this figure, a coherent light source, e.g., a laser, is shown as a spot via a fiberoptic representing speckle-like intensity variation within the envelope. However, this artifact is improved by use of diffusion beads thus providing improved uniformity. The micro diffusers are further depicted in the schematic of FIG. 16 at the entrance of the rectangular fiberoptic. These beads which are not shown to scale are provided on a substrate, e.g. glass, and mechanically coupled to the rectangular fiberoptic of the present disclosure. The beads are aligned and bonded to the substrate using a bonding agent and cured utilizing, e.g., a UV curing light, as shown in FIG. 17.

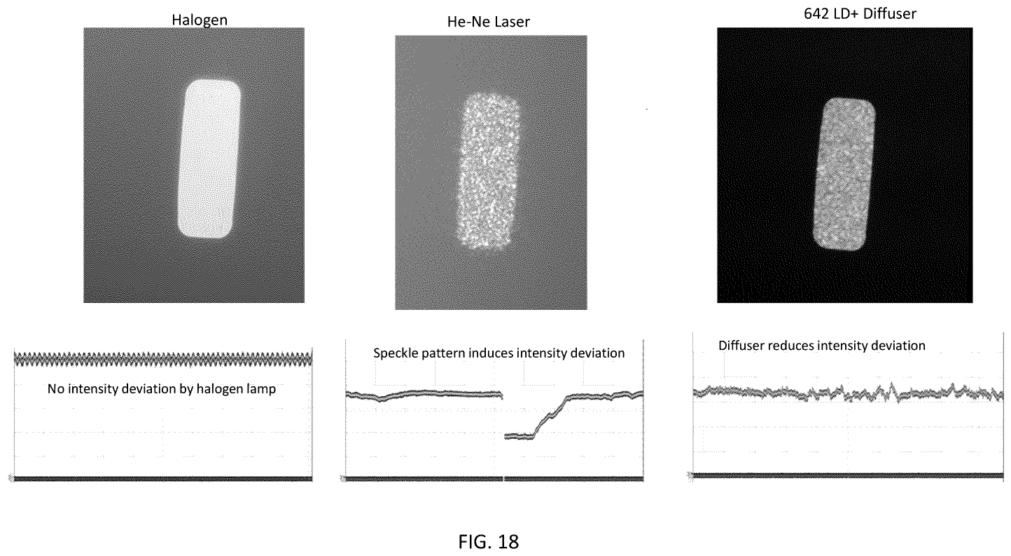

Referring to FIG. 18, rectangular fiberoptic output of three different light sources are shown (first one is an incoherent halogen light source where no deviation in light intensity within the rectangular enveloped is observed, the second one is a coherent He—Ne laser where within the rectangular envelope a speckle-like variation in intensity is observed, and the third light source is a laser diode (642 nm) with diffuser beads showing a considerable reduction in the speckle-like variation of intensity within the rectangular envelope).

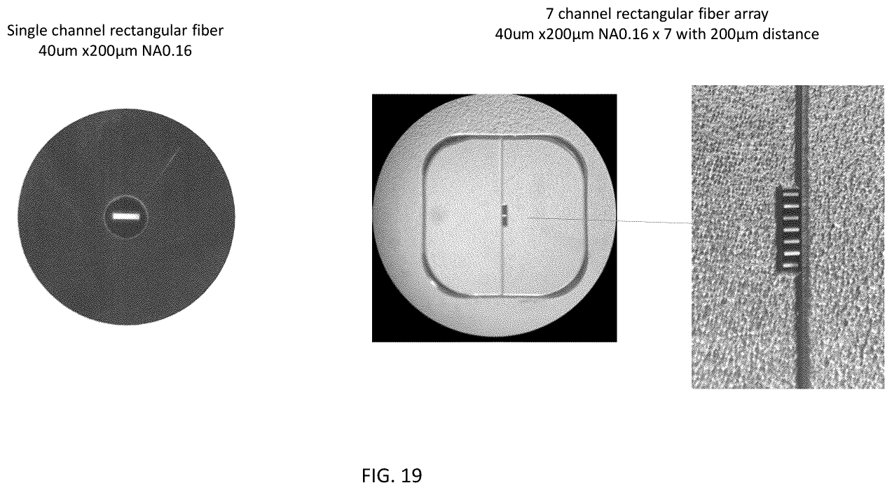

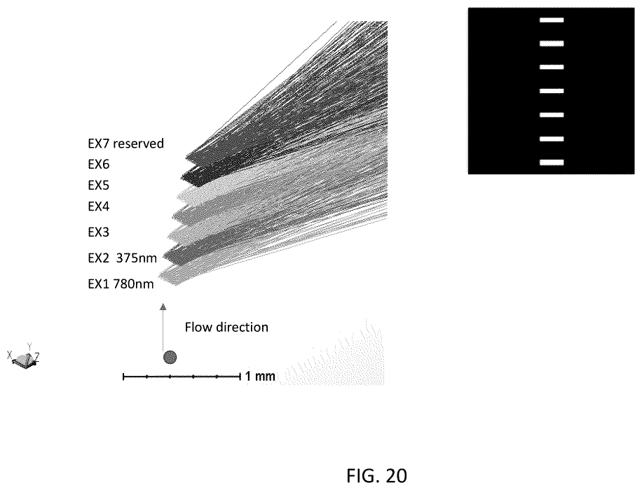

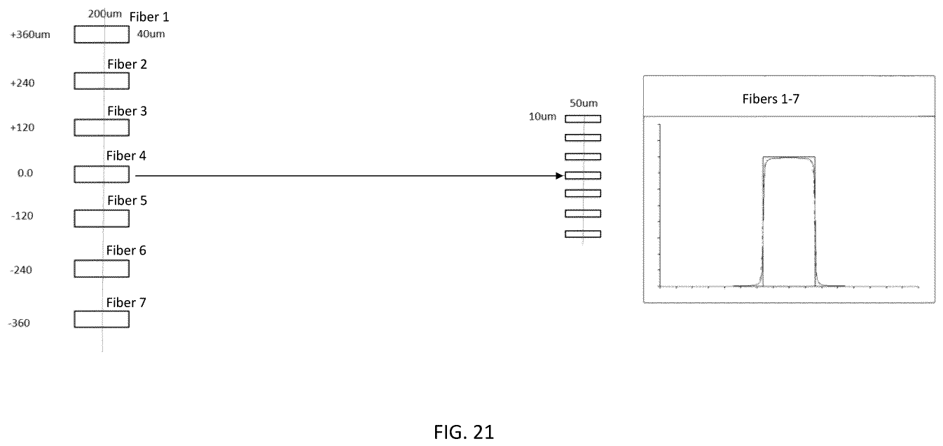

Referring to FIG. 19, the aforementioned advantage of the fiber array is further depicted. Output of a single channel rectangular fiber of 40 μm by 200 μm (H×W) is shown next to output of a 7-channel, each channel having a 40 μm by 200 μm (H×W) rectangular fiberoptic. The output of the array is shown in more detail in a zoomed window for added clarity. Each of the channels of the 7-channel array can be coupled to a corresponding light source, e.g., coherent lasers of different wavelengths as provided in FIGS. 20 and 21 without any interference from one channel to another. While not shown, each rectangular fiberoptic in the array shown in FIG. 19 may be configured with diffusion beads similar to what is shown in FIG. 16, thus combining the benefit of predefined distances between each output in the array with added benefit of improved uniformity when coupling the array to coherent light sources.

It should be emphasized that many variations and modifications can be made to the above-described examples, the elements of which are to be understood as being among other acceptable examples. All such modifications and variations are intended to be included herein within the scope of this disclosure and protected by the following claims. Moreover, in the claims, any reference to a group of items provided by a preceding claim clause is a reference to at least some of the items in the group of items, unless specifically stated otherwise.

1. A flow cytometry system, comprising:
a flow chamber configured to flow particles of interest in a flow stream;
one or more optical sources;
one or more rectangular fiberoptics optically each coupled to the one or more optical sources and further optically coupled to the flow chamber and configured to excite the particles of interest in the flow stream, the particles of interest emitting emission light in response to being excited by the excitation light;
one or more photodetectors configured to receive emission light from the particles of interest and, each in response generate a response signal,
wherein the one or more rectangular fiberoptics each generate a flattop intensity response in both direction of flow and in a direction perpendicular to the direction of flow.

2. The flow cytometry system of claim 1, wherein each of the one or more optical sources is a coherent light source.

3. The flow cytometry system of claim 1, wherein each of the one or more optical sources is an incoherent light source.

4. The flow cytometry system of claim 1, wherein one or more of the one or more rectangular fiberoptics is coupled to a substrate with diffusion beads disposed thereon.

5. The flow cytometry system of claim 1, wherein the one or more rectangular fiberoptics is arranged as an array with distance between each channel of the array to another channel of the array is predefined.

6. The flow cytometry system of claim 4, wherein the one or more rectangular fiberoptics is arranged as an array with distance between each channel of the array to another channel of the array is predefined.

7. The flow cytometry system of claim 1, wherein each of the one or more rectangular fiberoptics is formed based on a height (H) vs. width (W) having an aspect ratio of H×W of between 1×1 and 1×10, with height of the fiberoptic having a range of between about 10 to about 50 μm.

8. The flow cytometry system of claim 7, wherein each of the one or more rectangular fiberoptics is made of a homogenous transparent material.

9. The flow cytometry system of claim 8, wherein the homogenous transparent material is selected from the group consisting of fused silica, glass, plastic, and combinations thereof.

10. The flow cytometry system of claim 9, wherein plastic is selected from the group consisting of acrylate, polyimide, and a combination thereof.

11. The flow cytometry system of claim 5, wherein velocity of the particles of interest is determined based on time of flight between two neighboring channels.

12. The flow cytometry system of claim 11, wherein particle size of the particles of interest is determined based on the determined velocity and based on time of flight across one channel of the array.

13. A method of studying particles of interest in a flow cytometry system, comprising:
flowing particles of interest in a flow stream in a flow chamber;
activating one or more optical sources;
optically coupling one or more rectangular fiberoptics each to the one or more optical sources and further optically coupling to the flow chamber to thereby exciting the particles of interest in the flow stream, the particles of interest emitting emission light in response to being excited by the excitation light;
detecting the emission light from the particles of interest by one or more photodetectors, each in response generating a response signal,
wherein the one or more rectangular fiberoptics each generate a flattop intensity response in both direction of flow and in a direction perpendicular to the direction of flow.

14. The method of claim 13, wherein each of the one or more optical sources is a coherent light source.

15. The method of claim 13, wherein each of the one or more optical sources is an incoherent light source.

16. The method of claim 13, wherein one or more of the one or more rectangular fiberoptics is coupled to a substrate with diffusion beads disposed thereon.

17. The method of claim 13, wherein the one or more rectangular fiberoptics is arranged as an array with distance between each channel of the array to another channel of the array is predefined.

18. The method of claim 16, wherein the one or more rectangular fiberoptics is arranged as an array with distance between each channel of the array to another channel of the array is predefined.

19. The method of claim 13, wherein each of the one or more rectangular fiberoptics is formed based on a height (H) vs. width (W) having an aspect ratio of H×W of between 1×1 and 1×10, with height of the fiberoptic having a range of between about 10 to about 50 μm.

20. The method of claim 19, wherein each of the one or more rectangular fiberoptics is made of a homogenous transparent material.

21. The method of claim 20, wherein the homogenous transparent material is selected from the group consisting of fused silica, glass, plastic, and combinations thereof.

22. The method of claim 21, wherein plastic is selected from the group consisting of acrylate, polyimide, and a combination thereof.

23. The method of claim 22, wherein velocity of the particles of interest is determined based on time of flight between two neighboring channels.

24. The method of claim 23, wherein particle size of the particles of interest is determined based on the determined velocity and based on time of flight across one channel of the array.
